(19) United States
(12) Patent Application Publication
(10) Pub. No.: US 2016/0129287 A1
(43) Pub. Date: May 12, 2016

(54) Scent Suppression Mask

(71) Applicant: Training Mask, LLC, Cadillac, MI (US)

(72) Inventor: Casey Danford, Cadillac, MI (US)

(21) Appl. No.: 14/536,794

(22) Filed: Nov. 10, 2014

(51) Int. Cl. A62B 23/02; A62B 18/08; A62B 18/10; A62B 18/02

(52) U.S. Cl. CPC A62B 23/025; A62B 18/02; A62B 18/084; A62B 18/10

(57) ABSTRACT

A wearable scent suppression breathing mask configured to suppress the scents associated with an individual's breath. The breathing mask includes a face mask, an outer fabric layer overlaying the face mask, at least one air inlet valve assembly mounted within the face mask, and a plurality of air outlet valve assemblies mounted within the face mask and including at least one filter element to suppress the scent from an individual's breath. The at least one air inlet valve assembly is an inhalation permitting and exhalation restricting port, while the air outlet valve assemblies are inhalation preventing and exhalation permitting ports that control the flow of air.

### FIELD OF THE INVENTION

The present invention relates to wearable breathing masks and, more particularly, to wearable scent suppressing breathing masks.

### BACKGROUND OF THE INVENTION

Scent carrying compounds in a person's breath can be sensed by animals even at a great distance. This can be a problem for individuals taking part in activities which require their presence be obscured from animals, such as hunting, nature observation, and the like. There is a need to provide a scent suppressing means to help obscure an individual's presence from animals which does not interfere with the activity being engaged.

### SUMMARY OF THE INVENTION

In an embodiment, a scent suppression mask, comprising a face mask having an exterior surface, an interior surface, and a perimeter extending seal, wherein the face mask is adapted to overlay a user's mouth and nose; an outer layer overlaying the face mask and having a pair of straps with inter-engaging ends for affixing the face mask about the user's face; at least one air inlet valve assembly incorporated within the face mask; and at least one air outlet valve assembly incorporated within the face mask and including at least one scent suppression filter for suppressing the scent of the user's breath from exiting the at least one air outlet valve assembly.

In an embodiment, the at least one air inlet valve assembly includes a base having a support stem, a flexible diaphragm mounted to the support stem of the base, and an end cap mounted to the base and having a plurality of air flow permitting apertures, while the at least one air outlet valve assembly includes a base having a support stem, a flexible diaphragm mounted to the support stem of the base of the at least one air outlet valve assembly, and an end cap mounted to the base of the at least one air outlet valve assembly and having a plurality of air flow permitting apertures. In an embodiment, the at least one scent suppression filter is supported on the support stem of the base of the at least one air outlet valve assembly.

In an embodiment, the at least one scent suppression filter includes a scent suppression compound. In an embodiment, the at least one scent suppression filter is coated with the scent suppression compound. In an embodiment, the at least one scent suppression filter is inherently impregnated with the scent suppression compound. In an embodiment, the at least one scent suppression filter includes a plurality of scent suppression filters. In an embodiment, the plurality of scent suppression filters is stacked.

In an embodiment, the at least one air outlet valve assembly includes a sleeve mounted to the support stem of the base of the at least one air outlet valve assembly for retaining the plurality of filters and the diaphragm of the at least one air outlet valve assembly to the base of the at least one air outlet valve assembly. In an embodiment, the at least one air outlet valve assembly includes a plurality of air outlet valve assemblies.

In an embodiment, the diaphragm of the at least one air inlet valve assembly is moveable between a first position, in which the diaphragm is deflected inwardly away from an inner surface of the end cap of the at least one air inlet valve assembly when the user inhales, and a second position, in which the diaphragm contacts the inner surface of the end cap of the at least one air inlet valve assembly when the user exhales so as to block the airflow permitting passages of the end cap of the at least one air inlet valve assembly and restrict the flow of air out from the at least one air inlet valve assembly. In an embodiment, each of the diaphragms of the plurality of air outlet valve assemblies is moveable between a first position, in which the diaphragm of each of the air outlet valve assemblies is deflected outwardly when the user exhales so as to permit the flow of air out through the airflow permitting passages of the side air outlet valve assemblies, and a second position in which the diaphragm contacts a biasing element of the base of each of the air outlet valve assemblies when a user inhales so as to restrict the flow of air through the air outlet valve assemblies.

In an embodiment, each of the straps includes interior cutout configurations that are adapted to fit around and behind the user's ears. In an embodiment, each of the inter-engaging ends of the straps of the outer layer includes hook and loop fasteners. In an embodiment, the outer layer is made from a fabric material and the face mask is made from rubber. In an embodiment, the outer layer is made from an elastic material.

### BRIEF DESCRIPTION OF THE DRAWINGS

Reference is made to the following detailed description of the exemplary embodiment considered in conjunction with the accompanying drawings, in which:

FIG. 1 is a front elevational view of a wearable scent suppression mask constructed in accordance with an exemplary embodiment of the present invention, said mask being shown as worn by a user;

FIG. 2 is a front perspective view of the scent suppression mask shown in FIG. 1, but said mask being shown as detached from the user;

FIG. 3 is a rear perspective view of the scent suppression mask shown in FIG. 2;

FIG. 4 is an exploded perspective view of a face mask employed by the scent suppression mask shown in FIG. 3, showing the internal components of a plurality of air inlet and outlet valve assemblies employed by the mask;

FIG. 5 is a cross-sectional view, taken along section line 5-5 and looking in the direction of the arrows, of a side air outlet valve assembly illustrated in FIG. 1, with internal components thereof being shown in a first, undeflected position; and

FIG. 6 is a cross-sectional view of the side air outlet valve assembly illustrated in FIG. 5, but with the internal components thereof being shown in a second, deflected position.

### DETAILED DESCRIPTION OF THE EXEMPLARY EMBODIMENTS

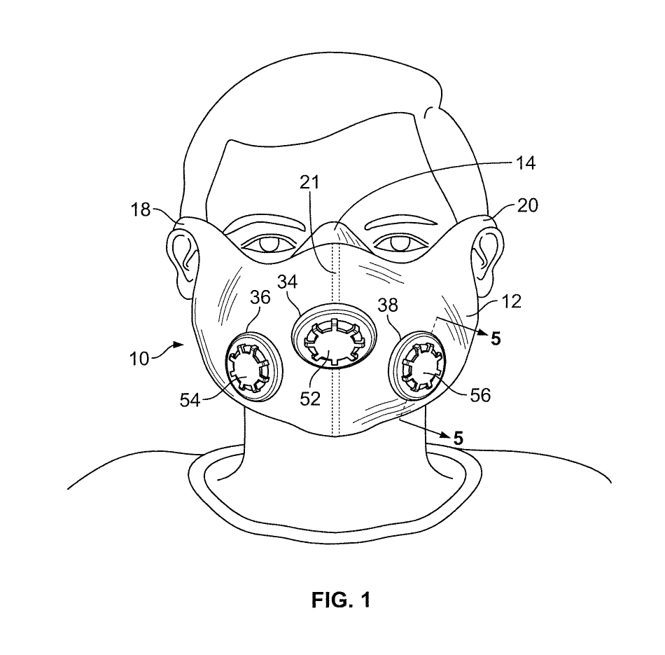

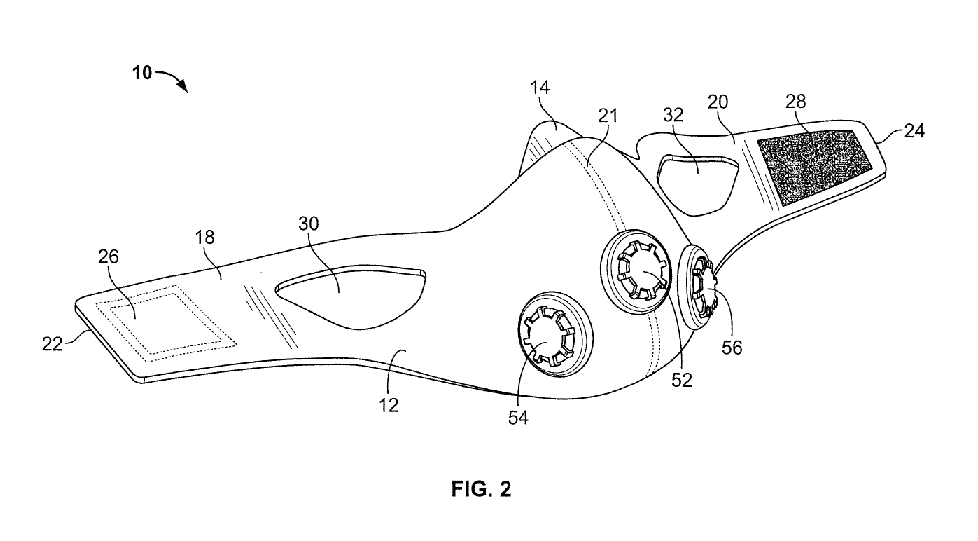

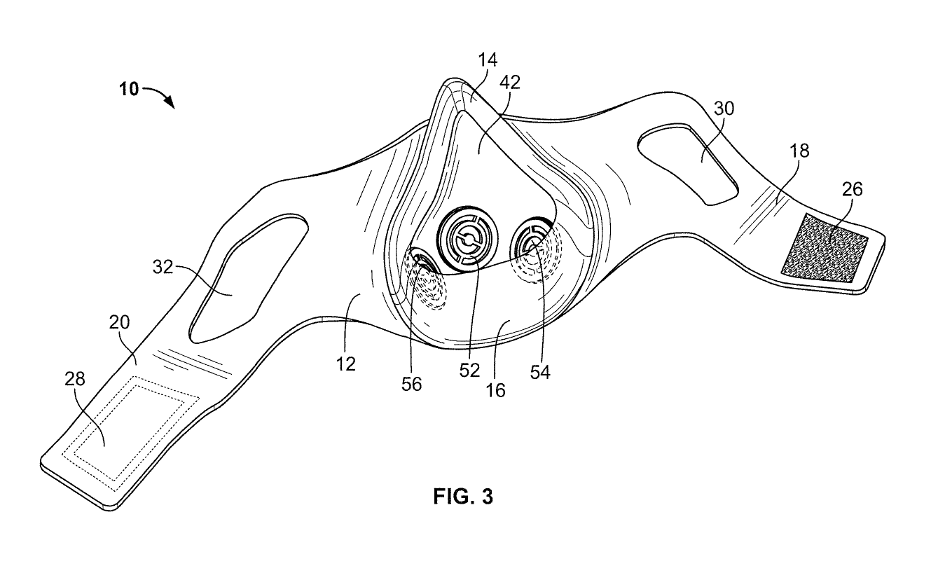

FIGS. 1-6 illustrate a scent suppression mask 10 (hereinafter, the “mask 10”) constructed in accordance with an exemplary embodiment of the present invention. In an embodiment, the mask 10 includes a two-layer construction, including an outer layer 12 overlaying a centrally-located, depth defining and air impermeable face mask 14 having a perimeter-extending seal 16 (as shown in FIG. 3). In an embodiment, the outer layer 12 and the face mask 14 have a construction and function similar to that disclosed in U.S. Patent Application Publication No. 2013/0319420 to Danford entitled “High Performance Ventilatory Training Mask Incorporating Multiple and Adjustable Air Admittance Valves for Replicating Various Encountered Altitude Resistances,” which is incorporated by reference herein in its entirety. In an embodiment, the outer layer 12 is made from a fabric material. In an embodiment, the outer layer 12 is made from an elastic material. In an embodiment, the face mask 14 is made from rubber. In another embodiment, the face mask 14 is made from other suitable materials known in the art that are adapted to provide an air-tight seal with a user's face. In an embodiment, the face mask 14 is sized, shaped, and adapted to overlay the nose and mouth of a user, as shown in FIG. 1. In an embodiment, the outer layer 12 includes a pair of straps 18, 20 that extend from a central location 21 overlapping the face mask 14. In an embodiment, the straps 18, 20 include ends 22, 24, respectively. In an embodiment, the ends 22, 24 of the straps 18, 20 incorporate corresponding hook and loop fasteners 26, 28 to enable the ends 22, 24 to be secured to one another and to enable affixing the mask 10 about the user's head (see, e.g., FIG. 1). In other embodiments, the ends 22, 24 of the straps 18, 20 include other securing means known in the art, such as clips, press-fit snaps, buttons, or the like. In an embodiment, the straps 18, 20 include cutout configurations 30, 32 by inner cutout area defining surfaces, for seating around and behind the user's ears to further secure the mask 10 to the user's face. In an embodiment, the outer layer 12 includes a central aperture 34 and a pair of side apertures 36, 38, each of which is located offset from and below the central aperture 34. In an embodiment, the side aperture 36 is located on one side of the central aperture 34 and the side aperture 38 is located on an opposite side of the central aperture 34. In an embodiment, each of the central aperture 34 and the side apertures 36, 38 are circular in shape.

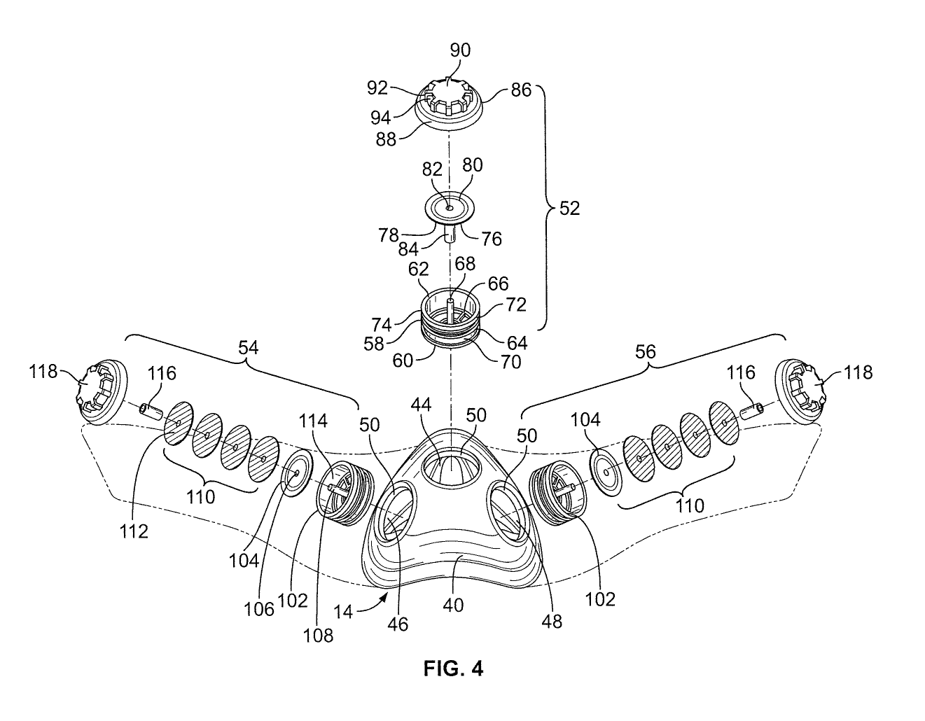

Referring to FIGS. 3 and 4, in an embodiment, the face mask 14 includes a front surface 40 and a rear surface 42 opposite the front surface 40, a circular-shaped, central aperture 44 extending from the front surface 40 to the rear surface 42, and a pair of circular-shaped side apertures 46, 48 extending from the front surface 40 to the rear surface 42, and each of which are located offset from and below the central aperture 44. In an embodiment, the side aperture 46 is located on one side of the central aperture 44 and the side aperture 48 is located on an opposite side of the central aperture 44. In an embodiment, when the outer layer 12 is overlayed on the face mask 14, the central aperture 34 of the outer layer 12 is aligned with the central aperture 44 of the face mask 14, and the side apertures 36, 38 of the outer layer 12 are aligned with the side apertures 46, 48 of the face mask, respectively. Each of the central aperture 44 and the side apertures 46, 48 includes an interior lip 50.

Referring to FIGS. 1 through 4, in an embodiment, the face mask 14 includes a central air inlet valve assembly 52 that is attached removably to the face mask 14 and positioned within the central aperture 44 thereof and extends through the central aperture 34 of the outer layer 12, and a pair of side air outlet valve assemblies 54, 56, each of which is attached removably to the face mask 14 and positioned within a corresponding one of the side apertures 46, 48 thereof and extends through the side apertures 36, 38 of the outer layer 12, respectively. In an embodiment, the central air inlet valve assembly 52 is an inhalation permitting and exhalation restricting port, while the side air outlet valve assemblies 54, 56 are inhalation preventing and exhalation permitting ports.

Referring to FIG. 4, in an embodiment, the central air inlet valve assembly 52 includes a substantially cylindrical base 58 having a first end 60, a second end 62 opposite the first end 60, and an exterior radial surface 64 extending therebetween. In an embodiment, a biasing element 66 is located at the first end 60 and from which extends a support stem 68. In an embodiment, the support stem 68 includes a length such that it extends outwardly beyond the second end 62 of the base 58. As can be seen in FIG. 4, the radial surface 64 includes a first radial groove 70 adapted to engage the lip 50 of the central aperture 44 of the face mask 14 to secure it thereto, and a second radial groove 72 adapted to receive the central aperture 34 of the outer layer 12 when the outer layer 12 is secured on the face mask 14. An upper lip 74 is provided radially along the second end 60 and extending outwardly therefrom.

Still referring to FIG. 4, in an embodiment, the central air inlet valve assembly 52 further includes a flexible, air impermeable, disc-shaped diaphragm 76 having a first surface 78, a second surface 80 opposite the first surface 78, a central opening 82, and a tubular post 84 extending from the first surface 78 and aligned with the central opening 82. In an embodiment, the diaphragm 76 is made of silicone. In an embodiment, the tubular post 84 is sized and shaped to receive the support stem 68 of the base 58 so as to enable the diaphragm 76 to be mounted on the base 58. In one embodiment, the tubular post 84 is formed integrally with the diaphragm 76 and extends generally perpendicularly from the first surface 78 thereof. In another embodiment, the tubular post 84 is a separate component from the diaphragm 76.

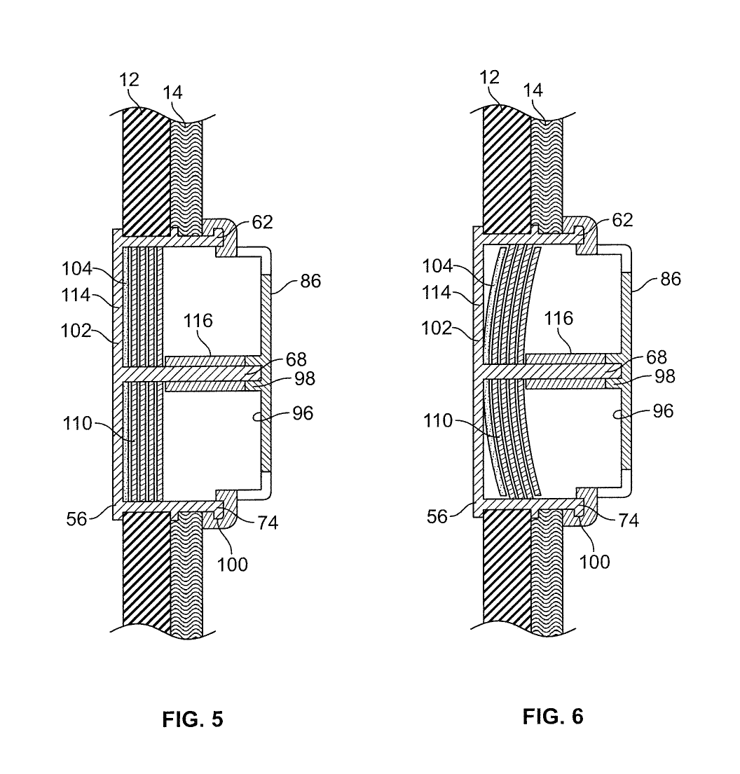

Continuing to refer to FIG. 4, the central air inlet valve assembly 52 further includes an end cap 86 having a circular-shaped base 88 and a raised top portion 90 connected to the base 88 by a plurality of radially extending legs 92. In an embodiment, the end cap 86 includes a plurality of air passages 94 between the legs 92 that enable the flow of air into the central air inlet valve assembly 52. In an embodiment, an inner surface 96 of the top portion 90 includes an integral tubular sleeve 98 extending perpendicularly therefrom which is sized and shaped to receive the support stem 68 of the base 58. The end cap 86 further includes an inner radial channel 100 formed therein which is sized and shaped to engage the lip 74 of the base 58 so as to snap on and secure it thereto (see, for example, FIGS. 5 and 6).

Still referring to FIG. 4, the side air outlet valve assemblies 54, 56 will now be described in detail. For the sake of brevity, only the side air outlet valve assembly 54 will be described in detail, as the side air outlet valve assemblies 54, 56 have an identical construction and function to one another. In an embodiment, the side air outlet valve assembly 54 includes a base 102 that is identical in construction to the base 58 of the central air inlet valve assembly 52, and, hence, the details of the base 102 will not be repeated herein. In an embodiment, the side air outlet valve assembly 54 includes a flexible, air impermeable, disc-shaped diaphragm 104 having a central aperture 106 that is sized and shaped to enable the diaphragm 104 to be mounted on a stem 108 of the base 102. In an embodiment, the diaphragm 104 is made of silicone. In an embodiment, the side air outlet valve assembly 54 includes a plurality of disc-shaped filters 110, each having a central aperture 112 that is sized and shaped to receive the stem 108 of the base 102 so as to be mounted thereon. In an embodiment, the filters 110 are porous. In one embodiment, the diaphragm 104 is positioned adjacent a biasing element 114 of the base 102 and the plurality of filters 110 is stacked thereon. As will be described in detail below, this configuration ensures that the side air outlet valve assembly 54 functions to restrict airflow into the face mask 14. In an embodiment, the plurality of filters 110 includes four of the filters 110. In other embodiments, the plurality of filters 110 can include more or less than four of the filters 110. In an embodiment, each of the plurality of filters 110 is adapted to filter odor causing compounds from a person's breath as it is exhaled through the side air outlet valve assembly 54. In an embodiment, each of the filters 110 may be made from carbon fibrous materials, cellulose gauze, or other suitable materials known in the art. In one embodiment, the filters 110 are each made from the same material or, in other embodiments, each of filters 110 is made from a different one of the foregoing materials, or some level of variation therebetween. In an embodiment, one or more of the filters 110, on either both sides or one side thereof, is coated with a scent suppressing compound. In an embodiment, one or more of the filters 110 is inherently impregnated with the scent suppression compound. In an embodiment, the scent suppressing compound includes water and baking soda. In another embodiment, the scent suppressing compound includes hydrogen peroxide, baking soda, and distilled water. In another embodiment, the scent suppressing compound includes salt water and baking soda. In an embodiment, the scent suppressing compounds are organic and all-natural.

Still referring to FIG. 4, the side air outlet valve assembly 54 includes a tubular sleeve 116 that is sized and shaped to receive the stem 108 of the base 102 to secure the filters 110 and the diaphragm 104 thereto. In an embodiment, the tubular sleeve 116 is made of silicone. In an embodiment, the side air outlet valve assembly 54 includes an end cap 118 that is identical in construction to the end cap 86 of the central air inlet valve assembly 52, and is secured to the base 102.

Referring now to FIGS. 1 through 4, the method of using the mask 10 according to an exemplary embodiment of the present invention will now be described. As an initial step, the mask 10 is strapped on a user's face via the straps 18, 20 and securing the ends 22, 24 to one another by the hook and loop fasteners 26, 28 and the inner cutouts 30, 32 are secured around the user's ears. Once in this configuration, the user is capable of adjusting the hook and loop fasteners 26, 28 to ensure sufficient force is provided to the face mask 14 such that the seal 16 is pressed tightly against the user's face. By such action, the user creates an airtight seal between the user's face and the face mask 14, thereby ensuring that air can only pass in through the central air inlet valve assembly 52 and out through the side air outlet valve assemblies 54, 56.

Continuing to refer to FIGS. 1 through 4, air inhalation can only occur through the central air inlet valve assembly 52. More particularly, when air is not being inhaled by the user, the second surface 80 of the diaphragm 76 of the central air inlet valve assembly 52 is located adjacent to and in contact with the inner surface 96 of the end cap 86. When the user inhales air through the plurality of air passages 94, the diaphragm is deflected inwardly so that air may pass therethrough. Conversely, when air is exhaled by the user, the second surface 80 of the diaphragm 76 will contact the inner surface 96 of the end cap 86 and be restrained from outward deflection, thereby ensuring that air cannot flow outwardly therethrough. In this manner, the central air inlet valve assembly 52 functions to only permit inflowing air through same, but restrict outflowing air.

Also, when air is not being exhaled by the user, the diaphragm 104 of each of the side air outlet valve assemblies 54, 56 is located adjacent to and in contact with the biasing element 114 of the base 102 (see FIG. 5). When the user exhales air, the diaphragm 104 is deflected outwardly such that air may pass therethrough (see FIG. 6). Conversely, when air is inhaled by the user, the diaphragm 104 will contact the biasing element 114 of the base 102 and be restrained from inward deflection, thereby ensuring that air cannot flow inwardly therethrough. In this manner, the side air outlet valve assemblies 54, 56 function to only permit outflowing air through same, but restrict the inflow of air.

With reference to FIGS. 5 and 6, the plurality of filters 110 are positioned intermediate the diaphragm 104 and the sleeve 116 of each of the side air outlet valve assemblies 54, 56. In an embodiment, each of the plurality of filters 110 is deformable to the extent that it will flex outwardly until biased against the sleeve 116 (see FIG. 6) such that air is forced to pass through the filters 110 prior to exiting the side air outlet valve assemblies 54, 56. This ensures that a filtering effect is provided to air that flows through the side air outlet valve assemblies 54, 56. In this manner, scent carrying compounds such as odorines and the like will be removed from the user's breath and retained within the filters 110, and air that exits the side air outlet valve assemblies 54, 56 will be substantially clear of any compounds which animals can smell and detect. In an embodiment, as described above, a scent suppression substance is added to the plurality of filters 110 to further increase the scent suppression effect.

It will be understood that the embodiments described herein are merely exemplary and that a person skilled in the art may make many variations and modifications without departing from the spirit and scope of the invention. All such variations and modifications are intended to be included within the scope of the invention, as embodied in the appended claims presented.

What is claimed is:

1. A scent suppression mask, comprising:
a face mask having an exterior surface, an interior surface, and a perimeter extending seal, wherein said face mask is adapted to overlay a user's mouth and nose;
an outer layer overlaying said face mask and having a pair of straps with inter-engaging ends for affixing the face mask about the user's face;
at least one air inlet valve assembly incorporated within said face mask; and
at least one air outlet valve assembly incorporated within said face mask and including at least one scent suppression filter for suppressing the scent of the user's breath from exiting said at least one air outlet valve assembly.

2. The scent suppression mask of claim 1, wherein said at least one air inlet valve assembly includes a base having a support stem, a flexible diaphragm mounted to said support stem of said base, and an end cap mounted to said base and having a plurality of air flow permitting apertures.

3. The scent suppression mask of claim 2, wherein said at least one air outlet valve assembly includes a base having a support stem, a flexible diaphragm mounted to said support stem of said base of said at least one air outlet valve assembly, and an end cap mounted to said base of said at least one air outlet valve assembly and having a plurality of air flow permitting apertures.

4. The scent suppression mask of claim 3, wherein said at least one scent suppression filter is supported on said support stem of said base of said at least one air outlet valve assembly.

5. The scent suppression mask of claim 4, wherein said at least one scent suppression filter includes a scent suppression compound.

6. The scent suppression mask of claim 5, wherein said at least one scent suppression filter is coated with said scent suppression compound.

7. The scent suppression mask of claim 5, wherein said at least one scent suppression filter is inherently impregnated with said scent suppression compound.

8. The scent suppression mask of claim 5, wherein said at least one scent suppression filter includes a plurality of scent suppression filters.

9. The scent suppression mask of claim 8, wherein said plurality of scent suppression filters is stacked.

10. The scent suppression mask of claim 8, wherein said at least one air outlet valve assembly includes a sleeve mounted to said support stem of said base of said at least one air outlet valve assembly for retaining said plurality of filters and said diaphragm of said at least one air outlet valve assembly to said base of said at least one air outlet valve assembly.

11. The scent suppression mask of claim 10, wherein said at least one air outlet valve assembly includes a plurality of air outlet valve assemblies.

12. The scent suppression mask of claim 11, wherein said diaphragm of said at least one air inlet valve assembly is moveable between a first position, in which said diaphragm is deflected inwardly away from an inner surface of said end cap of said at least one air inlet valve assembly when the user inhales, and a second position, in which said diaphragm contacts said inner surface of the end cap of said at least one air inlet valve assembly when the user exhales so as to block said airflow permitting passages of said end cap of said at least one air inlet valve assembly and restrict the flow of air out from said at least one air inlet valve assembly.

13. The scent suppression mask of claim 12, wherein each of said diaphragms of said plurality of air outlet valve assemblies is moveable between a first position, in which said diaphragm of each of said air outlet valve assemblies is deflected outwardly when the user exhales so as to permit the flow of air out through said airflow permitting passages of said side air outlet valve assemblies, and a second position in which said diaphragm contacts a biasing element of said base of each of said air outlet valve assemblies when a user inhales so as to restrict the flow of air through said air outlet valve assemblies.

14. The scent suppression mask of claim 1, wherein each of said straps includes interior cutout configurations that are adapted to fit around and behind the user's ears.

15. The scent suppression mask of claim 14, wherein said each of said inter-engaging ends of said straps of said outer layer includes hook and loop fasteners.

16. The scent suppression mask of claim 15, wherein said outer layer is made from a fabric material and said face mask is made from rubber.

17. The scent suppression of claim 15, wherein said outer layer is made from an elastic material.
